(19) United States
(12) Patent Application Publication
(10) Pub. No.: US 2013/0118307 A1
(43) Pub. Date: May 16, 2013

(54) DEVICE FOR PRODUCING GRANULAR METAL IRON AND PROCESS FOR PRODUCING GRANULAR METAL IRON

(71) Applicants: Shoichi Kikuchi, Kobe-shi (JP); Osamu Tsuge, Kobe-shi (JP)

(72) Inventors: Shoichi Kikuchi, Kobe-shi (JP); Osamu Tsuge, Kobe-shi (JP)

(73) Assignee: KABUSHIKI KAISHA KOBE SEIKO SHO (KOBE STEEL LTD), HYOGO (JP)

(21) Appl. No.: 13/811,782

(22) PCT Filed: Jul. 29, 2011
(86) PCT No.: PCT/JP11/67470

§ 371 Date: Jan. 23, 2013

(30) Foreign Application Priority Data
Aug. 9, 2010 (JP) 2010-178961

(51) Int. Cl. F27B 3/10; C21B 11/08; F27B 3/06

(52) U.S. Cl. CPC F27B 3/10; F27B 3/06; C21B 11/08
USPC 75/10.67; 266/171

(57) ABSTRACT

A device for producing granular metal iron by placing a mass of a raw material mixture comprising a substance containing iron oxide and a carbonaceous reducing agent onto a heath of a moving heath type heating furnace and heating the mass to reduce iron oxide in the mass, thereby producing the granular metal iron. The device comprises, in addition to the moving heath type heating furnace, a sieving machine, a first magnetic separator and a second magnetic separator, and also comprises a passage through which a discharged substance from the moving heath type heating furnace is supplied to the sieving machine, a passage through which crude granules that have been sieved by the sieving machine are supplied to the first magnetic separator, and a passage through which fine granules that have been sieved by the sieving machine are supplied to the second magnetic separator.

### TECHNICAL FIELD

The present invention relates to a device for producing granular metal iron in such a manner that a mass of a raw material mixture containing an iron oxide source and a carbonaceous reducing agent is placed onto a heath of a moving heath-type heating furnace and is heated and iron oxide in the mass is reduced and also relates to a process for producing granular metal iron.

### BACKGROUND ART

The following process is under development: a direct reduced iron production process for producing metal iron from a raw material mixture containing an iron oxide source (hereinafter referred to as “iron oxide-containing substance” in some cases) such as iron ore or iron oxide and a reducing agent (hereinafter referred to as “carbonaceous reducing agent” in some cases) containing carbon. In the direct reduced iron production process, a mass formed from the raw material mixture is placed onto a heath of a moving heath-type heating furnace and is heated in the furnace by gas heat transfer or radiation heat using a heating burner and thereby iron ore in the mass is reduced with the carbonaceous reducing agent, whereby granular metal iron can be obtained.

The granular metal iron obtained in the moving heath-type heating furnace is fed to a cooler with a feeding machine (feeder) and is cooled (Patent Literature 1). The temperature of the granular metal iron is usually about 900° C. to 1,000° C. at the point of time when the granular metal iron is fed to the cooler. After being cooled to about 150° C. in the cooler, the granular metal iron is discharged from the cooler. When the temperature of the granular metal iron discharged from the cooler is higher than 150° C., the granular metal iron reacts with moisture in air and therefore red rust is likely to form on the surface thereof.

When the granular metal iron is produced, slag is co-produced. A carbon material used as a floor covering is usually placed on the heath of the moving heath-type heating furnace for the purpose of protecting the heath from molten slag. Therefore, the granular metal iron is discharged from the moving heath-type heating furnace with the granular metal iron mixed with slag and the floor covering. Thus, in order to separate and recover only the granular metal iron from a substance discharged from the moving heath-type heating furnace, magnetic separation (jisen) or sieving needs to be performed.

Patent Literature 2 proposes a method for operating a moving heath-type heating furnace in which direct reduced iron having a size suitable for practical use is recovered in high yield and the downsizing and maintenance frequency of a facility are rare. This literature describes that a reduced product produced in the moving heath-type heating furnace and a portion or the whole of a heath carbon material are discharged with a discharger and are then sieved, some or all of undersized pieces of the carbon material are magnetically separated, magnetically separated undersized pieces of the carbon material are recycled as the heath carbon material.

### CITATION LIST

### Patent Literature

PTL 1: Japanese Unexamined Patent Application Publication (Translation of PCT Application) No. 2009-530501

PTL 2: Japanese Unexamined Patent Application Publication No. 2008-189972

### SUMMARY OF INVENTION

### Technical Problem

As described in Patent Literature 1, when the substance discharged from the moving heath-type heating furnace is cooled to about 150° C., the floor covering mixed with the discharged substance is also cooled to about 150° C. On the other hand, the inside of the moving heath-type heating furnace is heated at about 1,200° C. to 1,500° C. Therefore, if the cooled floor covering is returned to the moving heath-type heating furnace and is reused, then the temperature of the inside thereof is lowered. Thus, in order to reuse the floor covering without lowering the temperature of the inside thereof, the floor covering needs to be reheated. Furthermore, in the case of cooling the discharged substance, the sensible heat of the granular metal iron cannot be effectively used.

Patent Literature 2 describes that the undersized pieces of the carbon material that are obtained by sieving the reduced product and the discharged carbon material through a screen are magnetically separated. However, direct reduced iron remaining on a sieve is directly recovered as a product. Investigations performed by the inventors have revealed that oversized pieces contain slag and the like in addition to direct reduced iron and therefore the yield of direct reduced iron obtained by the method disclosed in Patent Literature 2 is low.

The present invention has been made in view of the foregoing circumstances. It is an object of the present invention to provide a device capable of producing granular metal iron in high yield. It is another object of the present invention to provide a process which is capable of reusing a floor covering contained in a substance discharged from a moving heath-type heating furnace without reheating the floor covering and which is capable of producing high-temperature granular metal iron.

### Solution to Problem

A device for producing granular metal iron according to the present invention, the device being capable of solving the above problems, is one for producing granular metal iron in such a manner that a mass of a raw material mixture containing an iron oxide source and a carbonaceous reducing agent is placed onto a heath of a moving heath-type heating furnace and is heated and iron oxide in the mass is reduced. The device has such an outline that the device includes the moving heath-type heating furnace, a sieving machine, a first magnetic separator, a second magnetic separator, a passage through which a substance discharged from the moving heath-type heating furnace is supplied to the sieving machine, a passage through which coarse granules separated with the sieving machine are supplied to the first magnetic separator, and a passage through which fine granules separated with the sieving machine are supplied to the second magnetic separator.

The device preferably further includes a passage through which a nonmagnetic substance sorted with the second magnetic separator is returned to the moving heath-type heating furnace.

A process for producing granular metal iron according to the present invention, the process being capable of solving the above problems, is one for producing granular metal iron in such a manner that a mass of a raw material mixture containing an iron oxide source and a carbonaceous reducing agent is placed onto a heath of a moving heath-type heating furnace and is heated and iron oxide in the mass is reduced. The process has such an outline that the process includes sieving a substance discharged from the moving heath-type heating furnace into coarse granules and fine granules at 200° C. to 650° C. with a sieving machine, separating the coarse granules obtained by sieving into a magnetic substance and a nonmagnetic substance with a first magnetic separator, separating the fine granules obtained by sieving into a magnetic substance and a nonmagnetic substance with a second magnetic separator, and returning the nonmagnetic substance sorted with the second magnetic separator to the moving heath-type heating furnace.

The magnetic substance sorted with the first magnetic separator and/or the magnetic substance sorted with the second magnetic separator is returned to a steelmaking furnace and thereby can be used as an iron source. The threshold is preferably set to 2 mm to 8 mm in terms of granule diameter before the substance discharged from the moving heath-type heating furnace is sieved into the coarse granules and the fine granules with the sieving machine.

### Advantageous Effects of Invention

According to a device for producing granular metal iron according to the present invention, the efficiency of magnetic separation can be enhanced in such a manner that coarse granules and fine granules separated with a sieving machine are sorted with respective appropriate magnetic separators; hence, the rate of recovery of granular metal iron can be increased.

According to a process for producing granular metal iron according to the present invention, a substance discharged from a moving heath-type heating furnace is sieved into coarse granules and fine granules at 200° C. to 650° C. with a sieving machine and the coarse granules and fine granules obtained by sieving are separately sorted with respective appropriate magnetic separators under appropriate conditions; hence, a floor covering contained in the discharged substance can be returned to the moving heath-type heating furnace with floor covering maintained at high temperature. Thus, granular metal iron can be produced in such a way that the loss of energy due to the reuse of the floor covering is reduced. Furthermore, granular metal iron can be recovered at the above temperature by sieving with the granular metal iron maintained at high temperature and therefore the sensible heat of the granular metal iron can be effectively used.

### BRIEF DESCRIPTION OF DRAWING

FIG. 1 is an illustration showing steps of producing granular metal iron from a mass.

### DESCRIPTION OF EMBODIMENTS

In order to produce granular metal iron in such a manner that a mass of a raw material mixture containing an iron oxide source and a carbonaceous reducing agent is placed onto a heath of a moving heath-type heating furnace and is heated and iron oxide in the mass is reduced, the inventors have conducted intensive investigations for the purpose of increasing the rate of recovery of granular metal iron and for the purpose of producing granular metal iron in such a manner that the loss of energy is reduced when a floor covering contained in a substance discharged from the moving heath-type heating furnace is reused in the moving heath-type heating furnace. As a result, it has been revealed that when granular metal iron is separated by directly subjecting the substance discharged from the moving heath-type heating furnace to a magnetic separator, fine granules adhere to a drum of the magnetic separator and the rate of recovery of coarse granules is lowered. It has been found that the rate of recovery of granular metal iron can be increased in such a manner that the substance discharged from the moving heath-type heating furnace is separated into coarse granules and fine granules with a sieving machine and the coarse granules and the fine granules are separately sorted with respective appropriate magnetic separators, because the efficiency of magnetic separation can be enhanced as compared to the case where the substance discharged from the moving heath-type heating furnace is magnetically separated without sieving the substance discharged from the moving heath-type heating furnace into coarse granules and fine granules. Furthermore, it has been found that sieving the discharged substance at 200° C. to 650° C. allows granular metal iron to be produced in such a way that the loss of energy due to the reuse of the floor covering is reduced and also allows the sensible heat of the obtained granular metal iron, which remains at high temperature, to be effectively used, thereby completing the present invention. The present invention is described below.

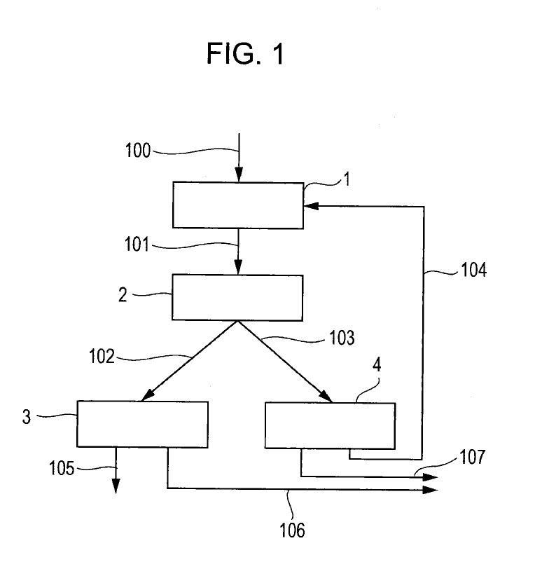

A device for producing granular metal iron according to the present invention is characterized by including a moving heath-type heating furnace, a sieving machine, a first magnetic separator, and a second magnetic separator. A stream (flow) for producing granular metal iron from a mass using the device is described below with reference to FIG. 1.

In FIG. 1, reference numeral 1 represents the moving heath-type heating furnace, reference numeral 2 represents the sieving machine, reference numeral 3 represents the first magnetic separator, and reference numeral 4 represents the second magnetic separator. The moving heath-type heating furnace 1 is connected to the sieving machine 2 through a passage 101. The sieving machine 2 is connected to the first magnetic separator 3 through a passage 102. The sieving machine 2 is connected to the second magnetic separator 4 through a passage 103. The second magnetic separator 4 is connected to the moving heath-type heating furnace 1 through a passage 104. In FIG. 1, reference numeral 100 represents a passage through which the mass is supplied to the moving heath-type heating furnace, reference numeral 105 represents a passage through which a nonmagnetic substance sorted with the first magnetic separator 3 is discharged, reference numeral 106 represents a passage through which a magnetic substance sorted with the first magnetic separator 3 is discharged, and reference numeral 107 represents a passage through which a magnetic substance sorted with the second magnetic separator 4 is discharged.

The flow for producing granular metal iron from the mass is as described in Items (1) to (5) below.

(1) First, a mass of a raw material mixture containing an iron oxide-containing substance and a carbonaceous reducing agent is placed onto a heath of the moving heath-type heating furnace 1 through the passage 100.

(2) Next, iron oxide in the mass is reduced by heating the mass placed on the heath of the moving heath-type heating furnace 1, whereby granular metal iron is produced.

When the granular metal iron is produced, slag derived from oxides contained in the mixture is co-produced. A carbon material used as a floor covering is usually placed on the heath for the purpose of protecting the heath from molten slag and for the purpose of promoting the reduction of iron oxide in the mass.

(3) The granular metal iron produced in the moving heath-type heating furnace 1 is discharged out of the furnace through the passage 101 together with the co-produced slag and the floor covering and is then supplied to the sieving machine 2. In the sieving machine 2, a substance discharged from the moving heath-type heating furnace 1 is separated into coarse granules and fine granules.

(4) The coarse granules separated with the sieving machine 2 are supplied to the first magnetic separator 3 through the passage 102 and are then magnetically separated. On the other hand, the fine granules separated with the sieving machine 2 are supplied to the second magnetic separator 4 through the passage 103 and are then magnetically separated. Separation is performed under appropriate conditions depending on a magnetic separation object using the first magnetic separator 3 and the second magnetic separator 4, whereby the efficiency of magnetic separation (the accuracy of magnetic separation) can be enhanced and the rate of recovery of the granular metal iron can be increased.

That is, the discharged substance adjusted in granule size by separating the coarse granules and the fine granules with the sieving machine 2 is magnetically separated, whereby the efficiency of magnetic separation can be enhanced as compared to the magnetic separation of the discharged substance not adjusted in granule size. In the case of being not adjusted in granule size, magnetic separation objects have different sizes and therefore have different masses. Therefore, even if the magnetic separation objects contain the same amount of iron, the magnetic separation objects are magnetically attracted or not magnetically attracted depending on the mass of the magnetic separation objects, leading to a reduction in magnetic separation efficiency. In contrast, if the magnetic separation objects are adjusted in granule size prior to magnetic separation, the size of the magnetic separation objects can be made even; hence, the mass of the magnetic separation objects is also made substantially even. Therefore, if conditions for magnetically separating the coarse granules and conditions for magnetically separating the fine granules are appropriately adjusted, the rate of recovery of granular metal iron can be enhanced.

(5) A nonmagnetic substance sorted with the second magnetic separator 4 may be returned to the moving heath-type heating furnace through the passage 104. The magnetic substance sorted with the second magnetic separator 4 may be supplied to a steelmaking furnace through the passage 107. The magnetic substance sorted with the first magnetic separator 3 may be supplied to the steelmaking furnace through the passage 106. The nonmagnetic substance sorted with the first magnetic separator 3 may be discharged through the passage 105.

A flow of Items (1) to (5) described above is described below in detail.

(1) As the iron oxide-containing substance, for example, iron ore, iron sand, steelmaking dust, nonferrous refining residue, steelmaking waste, or the like can be used.

As the carbonaceous reducing agent, a carbon-containing substance may be used and, for example, coal, coke, or the like can be used.

The mixture containing the iron oxide-containing substance and the carbonaceous reducing agent may be blended with another component such as a binder, an MgO-containing substance, or a CaO-containing substance. As the binder, for example, a polysaccharide (for example, starch such as flour or corn starch) or the like can be used. As the MgO-containing substance, the following material can be used: for example, an MgO powder, an MgO-containing substance extracted from natural ore or seawater, dolomite, magnesium carbonate (MgCO₃), or the like. As the CaO-containing substance, for example, quicklime (CaO) and limestone (a major component is CaCO₃) or the like can be used.

The mass is not particularly limited in shape and may be, for example, pellet-shaped or briquette-shaped.

The mass is placed onto the heath of the moving heath-type heating furnace 1 through the passage 100.

The moving heath-type heating furnace 1 is a heating furnace in which a heath moves like a belt conveyer. In particular, a rotary hearth furnace can be exemplified. In the rotary hearth furnace, the shape of a heath is designed to be circular (doughnut-shaped) such that the beginning and end of the heath are located at the same position. The mass supplied to the heath is heated and reduced while going round in the furnace, whereby granular metal iron is produced. Thus, a charge unit for supplying the mass to the furnace is placed most upstream in the direction of rotation and a discharge unit is placed most downstream in the direction of rotation (in actual, directly upstream of the charge unit because of a rotary structure).

(2) Conditions for heating and reducing iron oxide in the mass in the furnace are not particularly limited and may be known conditions. Reduction may be performed by heating the mass to, for example, 1,200° C. to 1,500° C. A burner is used to heat the inside of the furnace. The temperature of the mass can be adjusted by controlling combustion conditions in the burner.

The carbon material, which is used as the floor covering, is preferably placed onto the heath prior to supplying the mass to the heath. The floor covering acts as a member for protecting the heath and serves as a carbon supply source when carbon contained in the mass is short.

The thickness of the floor covering is not particularly limited and is preferably, for example, 3 mm to 30 mm. The carbon material, which is used as the floor covering, may be the carbonaceous reducing agent exemplified above. It is recommended that one containing particles with a size of about 0.5 mm to 3.0 mm is used as the carbon material. The carbon material contains fine carbon particles and therefore may possibly ignite in an oxygen-containing atmosphere at high temperature. Thus, it is necessary to control the concentration of oxygen in the atmosphere in a facility or apparatus in which a substance containing the carbon material is handled.

(3) As the sieving machine 2, known one may be used and, for example, a sieve (screen), an air classifier, or the like can be used.

The threshold used to separate the coarse granules and the fine granules with the sieving machine 2 may be an arbitrary granule diameter selected in the range of 2 mm to 8 mm. The threshold is a reference value for sieving particles into coarse particles and fine particles. Setting the threshold to, for example, 3 mm means that 3-mm diameter particles are separated such that the mass ratio of the 3-mm diameter particles in a coarse particle fraction and the 3-mm diameter particles in a fine particle fraction is 1:1.

The substance discharged from the moving heath-type heating furnace 1 needs to be sieved at 200° C. to 650° C. When the sieving temperature is extremely low, the temperature of the nonmagnetic substance sorted with the second magnetic separator 4 in a downstream step is low. Therefore, returning this nonmagnetic substance to the moving heath-type heating furnace 1 lowers the temperature of the inside of the furnace. This causes a reduction in energy efficiency. Thus, the sieving temperature is 200° C. or higher, preferably 250° C. or higher, and more preferably 300° C. or higher. However, even if coarse granules and fine granules obtained at a temperature of higher than 650° C. by sieving are directly supplied to magnetic separators, magnetic separation cannot be performed. Therefore, for magnetic separation, these coarse and fine granules need to be cooled, leading to a waste of energy. That is, since the Curie temperature of iron is 760° C., iron quickly loses its magnetism at a temperature exceeding the Curie temperature; hence, magnetic separation cannot be performed. Therefore, if sieving is performed at high temperature, cooling is required before magnetic separation. Thus, the sieving temperature is 650° C. or lower, preferably 630° C. or lower, and more preferably 610° C. or lower.

The substance discharged from the moving heath-type heating furnace 1 may be directly supplied to the sieving machine 2 when the temperature thereof is 200° C. to 650° C. However, the temperature of the discharged substance is usually about 900° C. to 1,000° C.; hence, the discharged substance is cooled to a temperature of 200° C. to 650° C. with a cooler (not shown) placed in the passage 101 connecting the moving heath-type heating furnace 1 to the sieving machine 2.

As the cooler, for example, a rotary cooler, a vibrating conveyor-type cooler, a pan conveyor-type cooler, or the like can be used.

(4) In the first magnetic separator 3, granular metal iron can be sorted in the form of a magnetic substance and slag can be separated in the form of a nonmagnetic substance. On the other hand, in the second magnetic separator 4, granular metal iron and iron-rich slag can be sorted in the form of a magnetic substance and the floor covering, slag, or slag-rich granular metal iron can be sorted in the form of a nonmagnetic substance.

In the first magnetic separator 3 and the second magnetic separator 4, it is recommended that magnetic separation is performed at 650° C. or lower. When the temperature of magnetic separation is higher than 650° C., the magnetism of iron decreases as described above, leading to a reduction in magnetic separation efficiency. Thus, the temperature of magnetic separation is preferably 650° C. or lower, more preferably 600° C. or lower, and further more preferably 550° C. or lower. From the viewpoint of reducing the loss of energy due to the reuse of a magnetic substance or nonmagnetic substance sorted by magnetic separation, it is recommended that the lower limit of the temperature of magnetic separation is about 200° C. The temperature of magnetic separation is preferably 300° C. or higher.

Magnets used in the first and second magnetic separators 3 and 4 may be known ones. Examples thereof include Al—Ni—Co magnets, Sm—Co magnets, and Nd—Fe—B magnets. In particular, the Al—Ni—Co magnets and the Sm—Co magnets can be preferably used because the decrease in magnetism thereof is slight at high temperature. It is recommended that the magnets used in the first and second magnetic separators 3 and 4 are protected by thermal insulation or cooling such that the magnetism thereof does not decrease.

(5) The nonmagnetic substance sorted with the second magnetic separator 4 is returned to the moving heath-type heating furnace through the passage 104 and thereby can be reused. In the present invention, sieving is performed at a high temperature of 200° C. to 650° C. in the sieving machine 2 and therefore the temperature of the nonmagnetic substance sorted with the second magnetic separator 4 can be increased. Thus, this nonmagnetic substance can be supplied to the moving heath-type heating furnace 1 with this nonmagnetic substance maintained at high temperature and therefore the loss of energy can be reduced. On the other hand, the magnetic substance sorted with the second magnetic separator 4 is supplied to the steelmaking furnace through the passage 107 and can be used as an iron source. The magnetic substance sorted with the first magnetic separator 3 is supplied to the steelmaking furnace through the passage 106 and can be used as an iron source. In the present invention, sieving is performed at a high temperature of 200° C. to 650° C. in the sieving machine 2 and therefore the magnetic substances sorted with the first and second magnetic separators 3 and 4, as well as the nonmagnetic substance sorted with the second magnetic separator 4, can be reused with the magnetic substances maintained at high temperature. Thus, the magnetic substances need not be reheated before being supplied to the steelmaking furnace and therefore the loss of energy can be reduced.

Supposing that the specific heat of granular metal iron is 0.17 kcal/kg, the difference of the sensible heat between granular metal iron at 650° C. and granular metal iron at 25° C. is 0.11 Gcal as given by the following equation:

0.17×1000×(650−25)=0.11 Gcal.

The sensible heat converted from 0.11 Gcal is 130 kWh per ton of granular metal iron. Thus, the sensible heat can be effectively used by supplying the magnetic substances maintained at 650° C. to the steelmaking furnace rather than supplying the magnetic substances cooled to 25° C. to the steelmaking furnace.

An example of the steelmaking furnace, which is supplied with the magnetic substances, is an electric furnace.

The nonmagnetic substance sorted with the first magnetic separator 3 is almost slag and therefore may be discarded or may be recycled as, for example, a base course material.

As described above, in a production device according to the present invention, coarse granules and fine granules separated with a sieving machine can be sorted with respective appropriate magnetic separators under appropriate conditions. Thus, the efficiency of magnetic separation can be enhanced and the rate of recovery of granular metal iron can be increased. Furthermore, in a production process according to the present invention, a substance discharged from a moving heath-type heating furnace is sieved into coarse granules and fine granules at 200° C. to 650° C. with a sieving machine and the coarse granules and fine granules obtained by sieving are separately sorted with respective appropriate magnetic separators under appropriate conditions; hence, a floor covering contained in the discharged substance can be returned to the moving heath-type heating furnace with the floor covering maintained at high temperature. Thus, granular metal iron can be produced in such a way that the loss of energy due to the reuse of the floor covering is reduced. Furthermore, in the production process according to the present invention, granular metal iron contained in the discharged substance can be transferred to a steelmaking furnace with the granular metal iron maintained at high temperature and therefore the sensible heat of the granular metal iron can be effectively used.

### INDUSTRIAL APPLICABILITY

According to the present invention, the rate of recovery of granular metal iron can be increased when the granular metal iron is produced in such a manner that a mass of a raw material mixture containing an iron oxide source and a carbonaceous reducing agent is placed onto a heath of a moving heath-type heating furnace and is heated and iron oxide in the mass is reduced.

1. A device, the device comprising:
a moving heath-type heating furnace;
a sieving machine;
a first magnetic separator;
a second magnetic separator;
a passage through which a substance discharged from the moving heath-type heating furnace is supplied to the sieving machine;
a passage through which coarse granules separated with the sieving machine are supplied to the first magnetic separator; and
a passage through which fine granules separated with the sieving machine are supplied to the second magnetic separator.

2. The device according to claim 1, further comprising:
a passage through which a nonmagnetic substance sorted with the second magnetic separator is returned to the moving heath-type heating furnace.

3. A process for producing granular metal iron, the process comprising:
sieving a substance discharged from a moving heath-type heating furnace into coarse granules and fine granules at a sieving temperature of from 200° C. to 650° C. with a sieving machine;
separating the coarse granules obtained by sieving into a magnetic substance and a nonmagnetic substance with a first magnetic separator;
separating the fine granules obtained by sieving into a magnetic substance and a nonmagnetic substance with a second magnetic separator; and
returning the nonmagnetic substance sorted with the second magnetic separator to the moving heath-type heating furnace,
wherein the granular metal iron is produced by a process comprising:
placing a mass of a raw material mixture comprising an iron oxide source and a carbonaceous reducing agent onto a heath of the moving heath-type heating furnace,
heating the mass, and
reducing the iron oxide in the mass.

4. The process according to claim 3, wherein the magnetic substance sorted with the first magnetic separator is returned to a steelmaking furnace.

5. The process according to claim 3, wherein the magnetic substance sorted with the second magnetic separator is returned to a steelmaking furnace.

6. The process according to claim 3, wherein a threshold is set to 2 mm to 8 mm in terms of granule diameter before the substance discharged from the moving heath-type heating furnace is sieved into the coarse granules and the fine granules with the sieving machine.

7. The process according to claim 3, prior to said sieving, the process further comprising:
supplying a mass of a raw material mixture comprising an iron oxide source and a carbonaceous reducing agent to a heath of the moving heath-type heating furnace,
heating the mass, and
reducing the iron oxide in the mass.

8. The process according to claim 3, wherein the sieving temperature is from 300° C. to 610° C.

9. The process according to claim 3, wherein said separating the coarse granules with the first magnetic separator and said separating the fine granules with the second magnetic separator are performed at a temperature of from 300° C. to 550° C.

10. The process according to claim 7, wherein the iron oxide source is iron ore, iron sand, steelmaking dust, nonferrous refining residue, or steelmaking waste.

11. The process according to claim 7, wherein the carbonaceous reducing agent is coal or coke.

12. The process according to claim 7, wherein the raw material mixture further comprises a binder.

13. The process according to claim 7, wherein the raw material mixture further comprises a substance comprising MgO.

14. The process according to claim 7, wherein the raw material mixture further comprises a substance comprising CaO.

15. The process according to claim 7, prior to said supplying, the process further comprises:
placing a floor covering comprising a carbon material onto the heath of the moving heath-type heating furnace.
